(19) United States
(12) Patent Application Publication
(10) Pub. No.: US 2017/0217577 A1
(43) Pub. Date: Aug. 3, 2017

(54) HYBRID AIRCRAFT

(71) Applicant: Hattar Tanin LLC, Novato, CA (US)

(72) Inventors: Saadeh HATTAR, Novato, CA (US); Volodymyr Tanin, Kiev (UA)

(21) Appl. No.: 15/424,658

(22) Filed: Feb. 3, 2017

Related U.S. Application Data
(60) Provisional application No. 62/290,490, filed on Feb. 3, 2016.

(51) Int. Cl. B64C 27/24; B64C 29/00; B64C 3/38

(52) U.S. Cl. CPC B64C 27/24; B64C 3/38; B64C 29/0025

(57) ABSTRACT

The disclosure provides a hybrid aircraft capable of being propelled by a vertical rotor(s) or a horizontal engine(s). The aircraft includes a fuselage defining a horizontal plane, two wings attached to opposite sides of fuselage and oriented substantially parallel to the horizontal plane, an engine(s) configured to generate propulsion in a horizontal direction, and a rotor(s) extending vertically from the fuselage and oriented over a first portion of each wing. Each wing includes a wing frame and an aircraft skin covering at least a portion of the wing frame. When the aircraft is being propelled by the rotor, the aircraft skin covering the first portion of each wing frame is removed or rotated to facilitate airflow through the rotors. When the aircraft is being propelled by the one or more horizontal engines, the aircraft skin may cover the first portion of the wing frame, facilitating aerodynamic lift and stability.

### CROSS REFERENCE TO RELATED APPLICATIONS

This application claims priority to U.S. Provisional Patent Application No. 62/290,490, entitled “INNOVATIVE TRANSPORT MEANS, PROVIDED WITH UNIQUE CONTROLS AND BIOMETRIC IDENTIFICATION WITH POSSIBILITY TO BRING EQUIPMENT FOR GENERATION, STORING AND RECOVERING OF RENEWABLE ENERGY,” filed Feb. 3, 2016, which is hereby incorporated by reference.

### TECHNICAL FIELD

This specification describes technologies relating to hybrid aircraft having both horizontal rotor and vertical engine propulsion means.

### BACKGROUND

Conventional aircraft, e.g., airplanes and helicopters, have their strengths and weaknesses. Large airplanes, for example, are able to fly at high speed and high altitudes for long distances. For example, modern commercial airplanes have a range of 3000-9000 miles and cruise at speeds between 150-600 mph. However, airplanes require a landing strip for takeoff and landing. Helicopters, on the other hand, can take-off and land on almost any flat surface. However, helicopters have comparatively small ranges (e.g., 200-1000 miles) and cruising speeds (e.g., 75-150 miles per hour) with the same fuel consumption as an airplane.

Hybrid aircraft, e.g., convertiplanes, heliplanes, and gyrodynes (hereinafter referred to as “heliplanes”), each enjoy some of the advantages provided by both airplanes and helicopters. However, each has its disadvantages. For example, heliplanes have a relatively low service ceiling, which is significantly lower from the service ceiling of airplanes and just 50% more than a conventional helicopter. In some heliplanes, the rotors are designed to function both for horizontal lift, as for a helicopter, and for vertical propulsion, as for an airplane. Because the characteristics required for both means of propulsion are different, the hybrid rotors are less than maximally effective for both purposes.

Heliplanes are also very expensive to produce. For example, the V-22 Osprey costs three time more to build than a top of the line MI-26 helicopter, and has nearly the same flight range at twice the fuel consumption per weight and 3.6-times less weight capacity. In part, this is due to the complicated construction process and demands for frequent maintenance. This is one reason that conventional helicopters are more frequently used for military and humanitarian purposes.

As such, a need exists for hybrid aircraft that combine the fast speeds, high altitudes, and long range of an airplane with the ability to take off and land on small surfaces, like a helicopter. There is also a need for hybrid aircraft that can be built in a more economically feasible fashion. Such hybrid aircraft would be particularly useful for travel and the shipment of goods to remote districts, islands, and sites of catastrophic and/or natural disasters.

### SUMMARY

The present disclosure addresses these and other needs by providing a hybrid aircraft with both a helicopter rotor system for vertical lift and engines for horizontal propulsion. The hybrid aircraft described herein are configured to have an open wing structure below the rotor system, which may or may not, be convertible to a closed wing structure when the aircraft is being propelled by the engine. Advantageously, this design allows for larger hybrid aircraft with larger fixed wings that would normally inhibit airflow through the rotor system.

The hybrid aircraft described herein allow for vertical take-off and landing, as with a helicopter, without compromising the height, speed, and range of an airplane. The aircraft also have a simpler design and, thus are more economically built, than conventional hybrid aircraft (e.g., the V-22 Osprey).

### BRIEF DESCRIPTION OF THE DRAWINGS

The implementations disclosed herein are illustrated by way of example, and not by way of limitation, in the figures of the accompanying drawings. Like reference numerals refer to corresponding parts throughout the drawings.

FIG. 1 illustrates an exemplary hybrid aircraft with two vertical rotor systems, two engines for horizontal propulsion, and collapsible wing shields, in an open wing configuration, in accordance with some implementations.

FIG. 2 illustrates an exemplary hybrid aircraft with two vertical rotor systems, two engines for horizontal propulsion, and collapsible wing shields, in a closed open wing configuration, in accordance with some implementations.

FIG. 3 illustrates an exemplary hybrid aircraft with one vertical rotor system, two engines for horizontal propulsion, and rotatable wing shields, in an open wing configuration, in accordance with some implementations.

### DETAILED DESCRIPTION

Reference will now be made in detail to implementations of the present application as illustrated in the accompanying drawings. The same reference indicators will be used throughout the drawings and the following detailed description to refer to the same or like parts. Those of ordinary skill in the art will realize that the following detailed description of the present application is illustrative only and is not intended to be in any way limiting. Other embodiments of the present application will readily suggest themselves to such skilled persons having benefit of this disclosure.

In the interest of clarity, not all of the routine features of the implementations described herein are shown and described. It will, of course, be appreciated that in the development of any such actual implementation, numerous implementation-specific decisions must be made in order to achieve the developer's specific goals, such as desired speeds and service range of the aircraft being constructed, which will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In one aspect, the disclosure describes a hybrid aircraft with one or more helicopter rotors (e.g., vertical rotors) attached to a fuselage, for vertical lift of the aircraft. In some embodiments, particularly where a single helicopter rotor is employed, the hybrid aircraft also includes an anti-torque rotor (e.g., a tail-rotor) mounted in the rear of the aircraft. The hybrid aircraft also includes a horizontal propulsion engine (e.g., a rotor or jet engine) for horizontal propulsion once the aircraft is airborne.

The hybrid aircraft disclosed herein have wing(s) extending from the fuselage, e.g., similar to fixed-winged on an airplane. However, a portion of each wing, located under the helicopter rotor, is configured (totally or partly) to be open air (e.g., an open frame) when the helicopter rotor is engaged. This facilitates airflow to and from the rotor, which would otherwise be disrupted by the wings. This is especially important for larger aircraft which require larger wings for lift and stability. In some embodiments, this portion of the wing is convertible between a first, open-air configuration and a second, closed configuration facilitating stability and lift while the aircraft is propelled using the horizontal propulsion engines.

In some embodiments, the open air configuration is realized by removing all material other than the supporting structuring elements of the wing, leaving empty space between these supporting structuring elements to allow wind stream from lifting (i.e. helicopter) rotor(s) running down without barrier, thus without lowering efficacy of lifting rotor(s) and without providing unnecessary load on the construction of the hybrid aircraft from wind stream from lifting rotor(s).

In some embodiments, the wings of the hybrid aircraft have collapsible shields, which cover the supporting structural elements under the lifting rotor, when the aircraft is operated in a plane-like mode. This maximizes stability and lift-force during operation in plane mode.

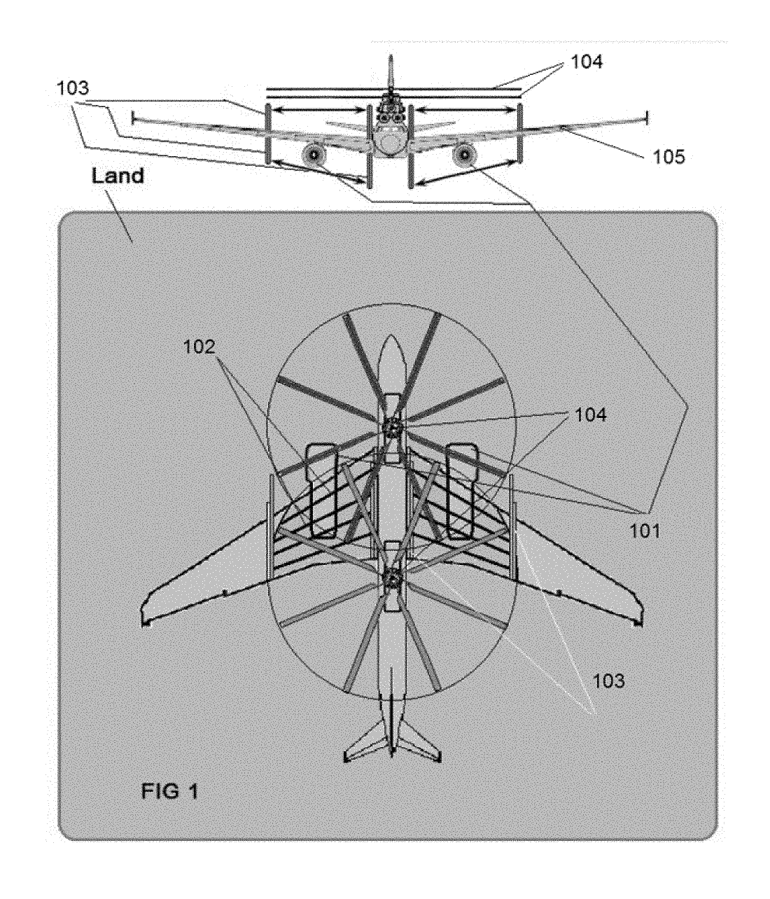

In some embodiments, as illustrated in FIG. 1, the wing shields collapse along the side of the fuselage when in the open configuration to minimize the amount of air-drag caused during forward motion.

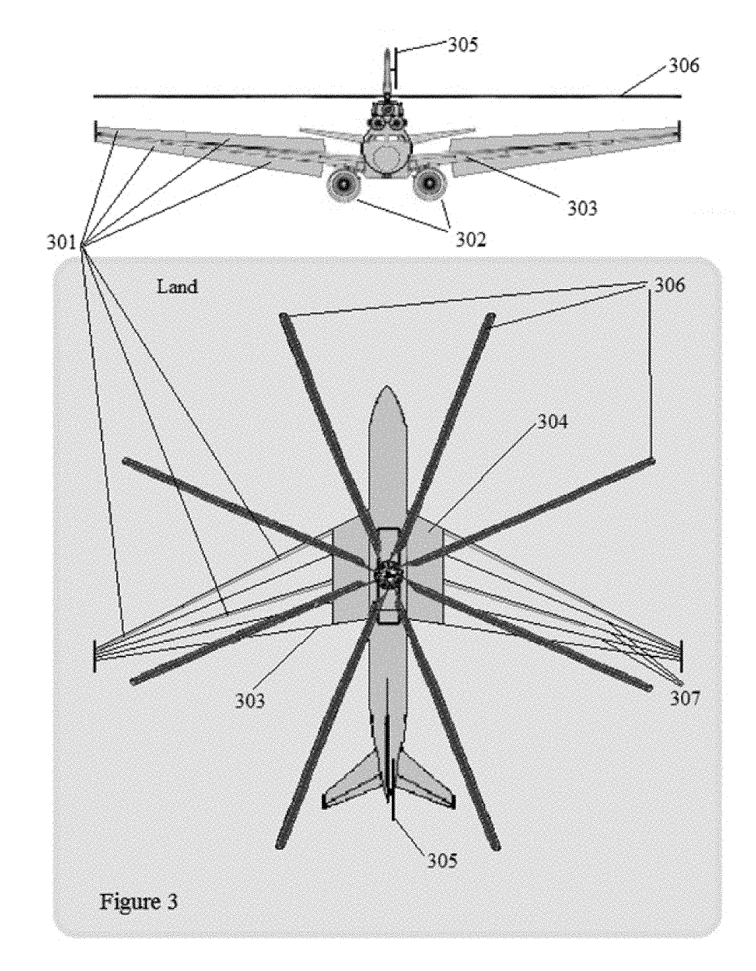

In other embodiments, as illustrated in FIG. 3, the wing shields rotate towards the and/or away from the lifting rotor (e.g., 90 degrees along a z-axis) to create an open-wing configuration facilitating airflow to and from the lifting rotors. In some embodiments, the collapsible shields are fixed and/or rotate about, structural elements of the wing's frames, e.g., along longerons running from the fuselage towards the ends of the wings.

Referring to FIG. 1, in some embodiments, the hybrid aircraft disclosed herein include a fuselage and wings 105 comprised of structural frame elements (e.g., longerons) 102 and an aircraft skin covering the frame. The aircraft skin includes collapsible/foldable shields 103 that cover the structural frame elements 102 when operating in plane mode, and which fold in and/or away from the fuselage when operating in helicopter mode. The hybrid aircraft includes two means of propulsion, one or more horizontal propulsion engines 101 (e.g., jet engines) and one or more vertical (e.g., helicopter) rotors 105.

In some embodiments, the hybrid aircraft includes a single lifting rotor. In some embodiments, where a single lifting rotor is used, the aircraft also includes an anti-torque tail rotor, e.g., mounted on the back of the aircraft.

In some embodiments, the hybrid aircraft include one or more standard forward-moving rotors/engines/jets and wings, like fixed wings used for commercial airplanes, however, a portion of the wings located below the blade-swept area of the helicopter-type (e.g., lift) rotor (s) (lifting rotor(s)) is in a configuration with open space between supporting structuring elements (e.g., longerons) to allow wind stream from the lifting rotor to flow downwards without barrier, improving the efficiency of the lifting rotors and avoiding unnecessary stress/load on the aircraft's structure (e.g., as applied by the airflow on wings in a a closed orientation). In some embodiments, this is accomplished through collapsible, rotatable, and/or retractable wing shields configured to cover the wings' structural elements when the aircraft in propelled by the vertical engines. In this fashion, the covered wings operate as normal plane wings, generating maximum lifting force and stability, when the hybrid aircraft in operating in airplane mode.

In one embodiment, the wing shields are collapsible shields that are retracted towards and/or away from the fuselage when operating in helicopter mode, to minimize air drag when moving forward, as illustrated in FIG. 1.

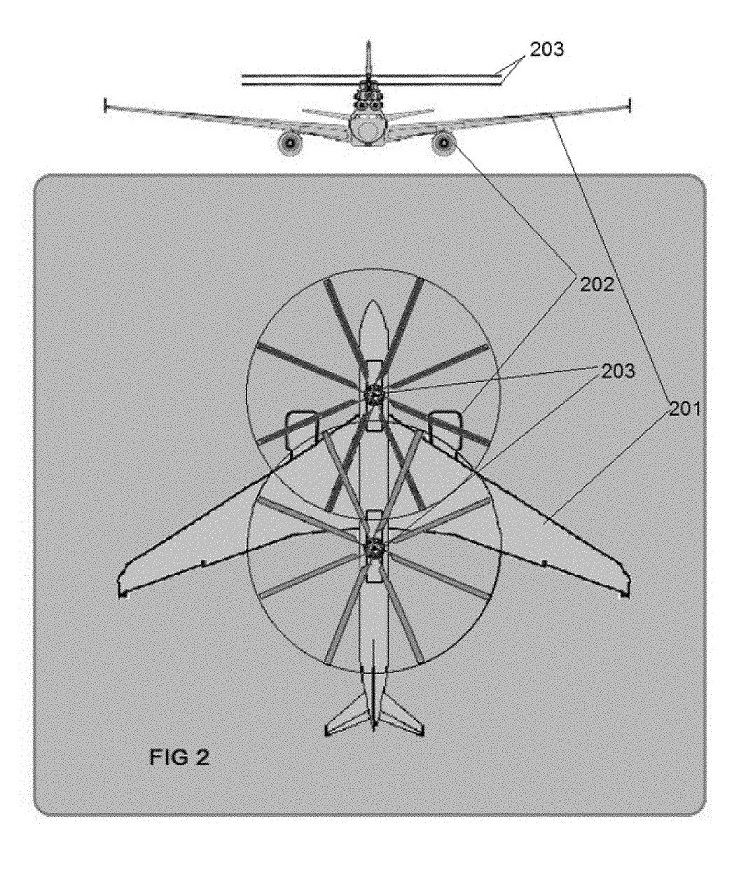

Referring to FIG. 2, when the hybrid aircraft is operated in airplane mode, (e.g., when being propelled by engines 202, rather than lifting rotor 203) the aircraft skin is configured to cover the entirety of the wings' structural elements, creating a solid wing 201. This increases lift and promotes stabilization of the aircraft when in plane mode.

Referring to FIG. 3, in some embodiments, the wing shields 301 are mounted on, and/or rotated about, structural elements 307 of the wings 303 (e.g., longerons) in order to generate an open configuration when operating in helicopter mode. In some embodiments, the portion 304 of the wing immediately proximate to the fuselage is in a closed orientation when operating in helicopter mode. In some embodiments, where the aircraft includes a single lifting rotor 306, the aircraft includes an anti-torque tail-rotor 305.

In some embodiments, the hybrid aircraft described herein include standard size plane-type wings (e.g., fixed wings such as those included on commercial airplanes), a standard helicopter rotor, an optional tail rotor, and standard jets. Since these are all existing components that can be used without significant modification, the construction process for the hybrid aircraft is simplified, as compared to conventional hybrid aircraft that require many custom components.

In some embodiments of the hybrid aircraft described herein, have a fixed configuration in which a first portion of the wings, located below the path of the lifting rotor blades, is open to airflow to and from the rotor. In these embodiments, the remaining portion of the wings, in a closed configuration, provide sufficient lift and stability when the aircraft is operated in airplane mode. Thus, in some embodiments, the wings do not include collapsible, rotatable, and/or retractable wing shields but, rather, have a fixed orientation with a first portion in an open configuration and a second portion in a closed configuration.

That is, in some embodiments, the hybrid aircraft have a fixed wing configuration similar to that illustrated in FIG. 1. In other embodiments, the hybrid aircraft has wings that are convertible between an open configuration, as illustrated in FIG. 1, and a closed configuration, as illustrated in FIG. 2.

In some embodiments, the hybrid aircraft described herein includes two lifting rotors and 2 or more (e.g., 2, 3, 4, 5, 6, 7, 8, or more) jet engines, e.g., as illustrated in FIGS. 1 and 2. This construction allows the aircraft to lift-off from any surface, and then fly (e.g., in plane mode) with a service ceiling, range, and speed of a commercial airplane. For example, using two rotor-engine blocks from an MI-26, and turbojets in necessary quantity with necessary capacity, the hybrid aircraft can achieve an operational payload of 40 metric tons.

In one embodiment, when the hybrid aircraft is on the ground, the collapsible wing shields are folded up, allowing efficient take-off using the lifting rotor. Once airborne, the aircraft shifts to engine propulsion (e.g., jet propulsion) and unfolds the collapsible wing shields. In some embodiments, once the aircraft has shifted to engine propulsion, the speed of the lifting rotors is lowered to eliminate lifting force, but kept at a speed sufficient to maintain tension on the blades as to minimize air pressure resistance and minimize fuel consumption.

Such construction of a hybrid aircraft improves safety by providing the ability to land in either airplane mode or helicopter mode, in case of an emergency.

In some embodiments, the disclosure provides drones with the hybrid configuration described herein, e.g., with both a lifting rotor and a propulsion engine. This is especially useful for transportation purposes, because it will allow delivery of items with a greater range of service and payload capacity on a single charge (and/or on a single portion of fuel), as compared to conventional drones. This allows the drone to take-off and land in a vertical orientation, reducing the area needed for landing and delivering objects with greater precision.

### SPECIFIC EMBODIMENTS

In one embodiment, the disclosure provides a hybrid aircraft (e.g., an aircraft capable of being operated in a helicopter-type mode or an airplane-type mode). The hybrid aircraft includes a fuselage defining a first horizontal plane traversing a midsection of the fuselage (e.g., a plane parallel to the ground when the aircraft is resting), two wings attached to opposite sides of fuselage (e.g., fixed wings 105, as illustrated in FIG. 1) and oriented substantially parallel to the first horizontal plane, each wing comprising a wing frame (e.g., including structural elements 102, as illustrated in FIG. 1) and an aircraft skin covering at least a portion of the wing frame. Each wing includes a first portion located proximal to the fuselage and a second portion located distal to the fuselage, with respect to the first portion of the wing. The aircraft also includes one or more engines (e.g., engines 101, as illustrated in FIG. 1) configured to generate propulsion in a direction substantially parallel to the first horizontal plane and a first rotor (e.g., rotors 104, as illustrated in FIG. 1) including a first plurality of blades mounted transversely on a first drive shaft. The first drive shaft extends vertically from the fuselage in an orientation substantially perpendicular to the first horizontal plane (e.g., rotors 104 are positioned above the fuselage in FIG. 1). Optionally, the angle of the drive shaft may be adjusted, to generate both vertical lifting up force and horizontal propulsion, as with conventional helicopters. The first plurality of blades are configured to rotate about the first drive shaft, thereby defining a first circle substantially parallel to the first horizontal plane (e.g., the circles shown around the blades of rotors 104 in FIG. 1). The first circle defined by the rotation of the first plurality of blades is positioned above at least the first portion of each wing proximal to the fuselage (e.g., as shown in FIG. 1, a portion of the circles defined by rotors 104 is located directly above wings 105. Each wing is configured such that in a first orientation (e.g., the open-wing orientation illustrated in FIG. 1), when the first rotor comprising the first plurality of blades is engaged (e.g., when rotors 104 are propelling the aircraft illustrated in FIG. 1), the aircraft skin does not cover the first portion of the wing frame (e.g., the portion of wings 105 under the blades of rotor 104 is in an open-wing configuration in FIG. 1).

In some embodiments, each wing of the hybrid aircraft is configured such that in a second orientation (e.g., as illustrated in FIG. 1), when the first rotor comprising the first plurality of blades is not engaged, the aircraft skin covers the first portion of the wing frame (e.g., the portion of wings 201 under the blades of rotors 203 is in a closed-wing configuration in FIG. 2). In other embodiments, the aircraft wings have a fixed configuration where the first portion of the wings is fixed in the open configuration (e.g., as illustrated in FIG. 1) regardless of whether the lifting rotor or propulsion engine is engaged.

In some embodiments, the aircraft skin covering the first portion of each wing frame in the second orientation (e.g., the closed-wing orientation illustrated in FIG. 2) is attached to a collapsible shield configured to fold away from the first portion of each wing frame in the first orientation (e.g., collapsible shields 103 fold off of wings 105, as illustrated in FIG. 1, to convert between closed and open-wing configurations).

In some embodiments, the collapsible shield (e.g., collapsible shield 103) is folded against the side of the fuselage in the first orientation.

In some embodiments, where the aircraft skin covering the first portion of each wing frame in the second orientation (e.g., the closed-wing orientation as illustrated in FIG. 2) is attached to a rotatable shield configured to rotate away from the first portion of each wing frame in the first orientation (e.g., rotatable shields 301 fold up and/or down from the frame of the wing frames in FIG. 3, to convert between closed and open-wing configurations).

In some embodiments, the aircraft also includes a second rotor (e.g., the aircraft in FIG. 1 includes two rotors 104) including a second plurality of blades mounted transversely on a second drive shaft. The second drive shaft extends vertically from the fuselage in an orientation substantially perpendicular to the first horizontal plane. The second plurality of blades are configured to rotate about the second drive shaft, thereby defining a second circle substantially parallel to the first horizontal plane. The first and second circles do not overlap on a same plane.

In some embodiments, the first circle and the second circle are located on a same plane substantially parallel to the first horizontal plane (e.g., the blade radius of the two rotors does not overlap).

In some embodiments, the first circle and the second circle are located on different planes that are both substantially parallel to the first horizontal plane (e.g., in FIG. 1, rotors 104 are located on different planes, allowing overlap of the respective blade radii.)

### CONCLUDING REMARKS

It will also be understood that, although the terms “first,” “second,” etc. may be used herein to describe various elements, these elements should not be limited by these terms. These terms are only used to distinguish one element from another. For example, a first object could be termed a second object, and, similarly, a second object could be termed a first object, without changing the meaning of the description, so long as all occurrences of the “first object” are renamed consistently and all occurrences of the “second object” are renamed consistently. The first object and the second object are both objects, but they are not the same object.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. A hybrid aircraft, comprising:
a fuselage defining a first horizontal plane traversing a midsection of the fuselage;
one, two or more wings attached to opposite sides of fuselage and oriented substantially parallel to the first horizontal plane, each wing comprising a wing frame and an aircraft skin covering at least a portion of the wing frame, wherein each wing comprises a first portion located proximal to the fuselage and a second portion located distal to the fuselage, with respect to the first portion of the wing;
one or more engines configured to generate propulsion in a direction substantially parallel to the first horizontal plane; and
a first rotor(s) (one or more) comprising a first plurality of blades mounted transversely on a first drive shaft, wherein:
the first drive shaft extends vertically from the fuselage in an orientation substantially perpendicular to the first horizontal plane,
the first plurality of blades are configured to rotate about the first drive shaft, thereby defining a first circle substantially parallel to the first horizontal plane, and
the first circle defined by the rotation of the first plurality of blades is positioned above at least the first portion of each wing proximal to the fuselage;
wherein each wing is configured such that in a first orientation, when the first rotor comprising the first plurality of blades is engaged, the aircraft skin does not cover the first portion of the wing frame.

2. The hybrid aircraft of claim 1, wherein each wing is configured such that in a second orientation, when the first rotor comprising the first plurality of blades is not engaged, the aircraft skin covers the first portion of the wing frame.

3. The hybrid aircraft of claim 1, wherein aircraft skin covering the first portion of each wing frame in the second orientation is attached to a collapsible shield configured to fold away from the first portion of each wing frame in the first orientation.

4. The hybrid aircraft of claim 3, wherein the collapsible shield is folded against the side of the fuselage in the first orientation.

5. The hybrid aircraft of claim 1, wherein aircraft skin covering the first portion of each wing frame in the second orientation is attached to a rotatable shield(s) configured to rotate away from the first portion of each wing frame in the first orientation.

6. The hybrid aircraft of claim 1, further comprising:
a second rotor comprising a second plurality of blades mounted transversely on a second drive shaft, wherein:
the second drive shaft extends vertically from the fuselage in an orientation substantially perpendicular to the first horizontal plane,
the second plurality of blades are configured to rotate about the second drive shaft, thereby defining a second circle substantially parallel to the first horizontal plane, and
the first and second circles do not overlap on a same plane.

7. The hybrid aircraft of claim 6, wherein the first circle and the second circle are located on a same plane substantially parallel to the first horizontal plane.

8. The hybrid aircraft of claim 6, wherein the first circle and the second circle are located on different planes that are both substantially parallel to the first horizontal plane.

9. The hybrid aircraft of claim 1, wherein aircraft skin covering the first portion of each wing frame is attached to a rotatable shield(s) configured to rotate away from the first portion of each wing frame in the first orientation, and shield(s) is/are attached and rotate along the structural elements of wing-longerons.
